(19) United States
(12) Patent Application Publication
(10) Pub. No.: US 2005/0124357 A1
(43) Pub. Date: Jun. 9, 2005

(54) Method for transmitting address information to a global positioning system from a personal digital assistant or other similar device via a connector

(75) Inventors: Indran Naick, Cedar Park, TX (US); Jeffrey Kenneth Wilson, Austin, TX (US)

Correspondence Address: IBM Corporation;IP Law Department, 11400 Burnet Road, Austin, TX, 78758, US

(73) Assignee: International Business Machines Corporation, Armonk, NY (US)

(21) Appl. No.: 10/728,166

(22) Filed: Dec. 4, 2003

(51) Int. Cl. H04Q 7/20

(52) U.S. Cl. 455/456.6

(57) ABSTRACT

A comprehensive method for transmitting address information to a global positioning system (GPS) from a personal digital assistant (PDA) display device or other similar device that stores address information, such as a cellular phone address book, or a laptop computer address book, via a connector. The connector can be Bluetooth, infrared, cable, or some other connector. This transmission of address information is much quicker than the current art of manually entering address information into the GPS, or transferring the address information from a DVD, and the errors associated with the current art of entering in such information are not present when the address information is transmitted via a connector.

### TECHNICAL FIELD

The present invention relates to information sent from one device, such as a personal digital assistant (PDA), cellular phone address book, laptop computer address book, or other similar device, to a global positioning system (GPS) via a connector without manual entering in of such information.

### BACKGROUND OF RELATED ART

Personal Digital Assistant (PDA) display terminals, such as the 3Com PalmPilot™ and International Business Machines Corporation's (IBM) WorkPad™ have been building a user base over the past few years. Current estimates are that there are a few million of these devices in present usage. While these personal devices have found limited selective markets among users with specific needs and habits, they have not, as yet, found the widespread appeal which was expected when they first began to appear almost a decade ago. Consequently, the technology is seeking applications of greater mass appeal. One area of great potential is in the area of wireless communication. In this connection, uses involving communication with the Internet through wireless and conventional modems has substantially increased the market for personal display devices. However, even such communication requires a fair degree of computer sophistication on the part of the user. In order for the PDA to reach its full potential market, applications accessible to even the computer indifferent user are needed. Wireless communication systems, particularly such systems which keep track of the user's position and path of movement and then provide information relative to the user and his position, should provide such an application. The combination of PDA technology with wireless communication and positioning systems such as Global Positioning Systems (GPS) provide the existing technology to support such a technology.

By way of background, the most common personal digital assistant is the PalmPilot™ line produced by 3Com Corp.; also available is the IBM WorkPad™. These devices are comprehensively described in the text, Palm III & PalmPilot, Jeff Carlson, Peachpit Press, 1998. They contain a data processor, operating systems: Palm OS 2.0 or 3.0, and about 1 to 2 MB of random access memory (RAM). They also have a networking protocol: TCP/IP, which permits connection to the Internet through PDA modems, which are described in greater detail at pp. 148-149 of the above-described text. In addition, there is available for PDAs such as the PalmPilot GPS, which is described in the above text on page 231. In general, global positioning is a well known and developed system which uses groups of three satellites which receive signals from the moving unit being positioned and use this signal data to triangulate and, thus, position the moving unit. The hardware required for such global positioning has been miniaturized to the point that it may be attached to and associated with PDA displays, e.g. a palm held device, without any significant change in the size and weight of the personal display device.

In the current art relating to GPS systems, addresses are received from either a list of addresses on a DVD, or from direct user input. The manual entering of addresses involved in direct user input is cumbersome, time consuming, and not without errors, particularly errors related to unnecessary repetitious entries when an address may have already been entered in a cellular phone or PDA.

### SUMMARY OF THE PRESENT INVENTION

The present invention provides a user the ability to transfer address information stored on a PDA, cellular phone address book, laptop computer address book, or other such application or list to a GPS system without the manual entering of the address information by using Bluetooth, infrared, cable, or through some other connector. Bluetooth is a technology protocol developed to wirelessly connect electronic devices such as wireless phones, PDAs, and computers, and can exchange information therewith within about a 30 foot range via radio waves in the 2.45 gigahertz (GHz) spectrum.

Accordingly, the present invention involves a wireless communication system for distributing address information to a GPS navigation system from stored information on a PDA, or some other similar device. The key to the invention is the use of a connector to transmit the address information to populate the GPS address field that traditionally had to be manually entered. This invention allows a user to more quickly enter address information from a stored location into a GPS without the risk of error associated with the previous method of manually entering in such information.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized view of the elements of the present invention as implemented by a user;

FIG. 2 is a generalized view of an apparatus which may be used to provide the user with access to address information;

FIG. 3 is a generalized block view of a conventional personal digital display assistant set up to carry out the present invention;

FIG. 4 is a view of a personal digital assistant display showing to the user a menu of address information available for transmission to a GPS;

FIG. 5 is an illustrative flowchart describing the setting up of the functions to transmit addresses from a device with addresses stored thereon to a global positioning system via a connector; and

FIG. 6 is a flowchart of an illustrative run of the program set up according to FIG. 5, wherein an address is transmitted via a connector from a device with addresses stored thereon to a global positioning system.

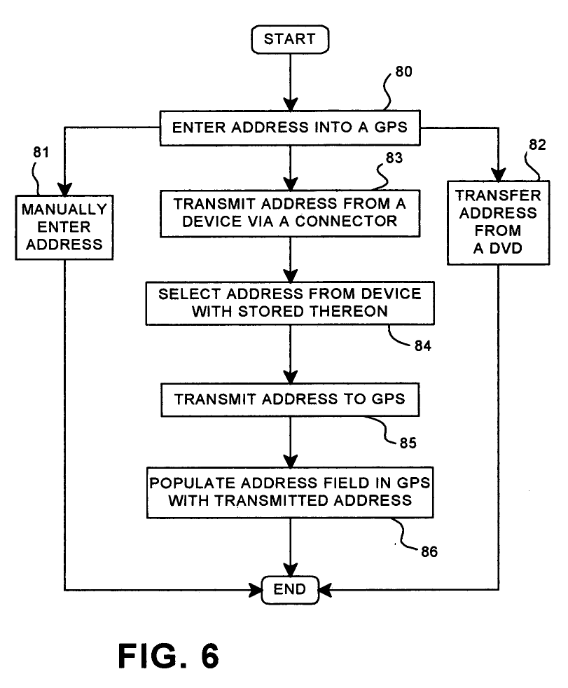

### DETAILED DESCRIPTION OF THE PREFERRED EMBODIMENT

Before going into the details of specific embodiments, it will be helpful to understand from a more general perspective the various elements and methods which may be related to the present invention. An important element in the present invention is a position tracking system. At the present time, GPS have achieved a considerable amount of acceptance for general positional sensing. As will be subsequently described, the display terminal would have wireless receiving means for accepting the transmission of address information from a PDA or other such device which has address information stored thereon.

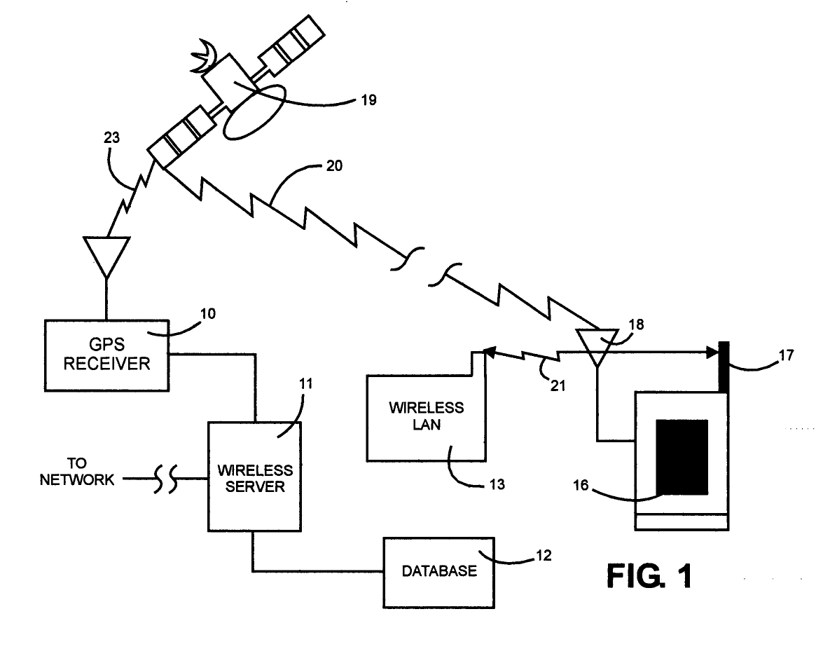

FIG. 1 provides a view of a GPS navigation system including a GPS receiver 10 attached to a PDA 16 which is made up of antenna 18, communication channel 20 up to the triangulating satellites which are represented by satellite 19 which then communicates the position of a PDA 16 via transmission channel 23 to the antenna of GPS receiver 10 associated with server 11 of the low power local wireless transmission system which accesses local database 12 to transmit via a local area network (LAN) 13 via channel 21 to the wireless receiver terminal 17 of the PDA 16. In the present invention, the PDA 16 also transmits address information to the GPS receiver 10. In operation, the request for data is transmitted from the PDA 16 to the server 11 via a connector 21, and the server 11 accesses appropriate information from the PDA 16 and transmits pertinent address information to the GPS receiver 10, and into address fields of the database 12.

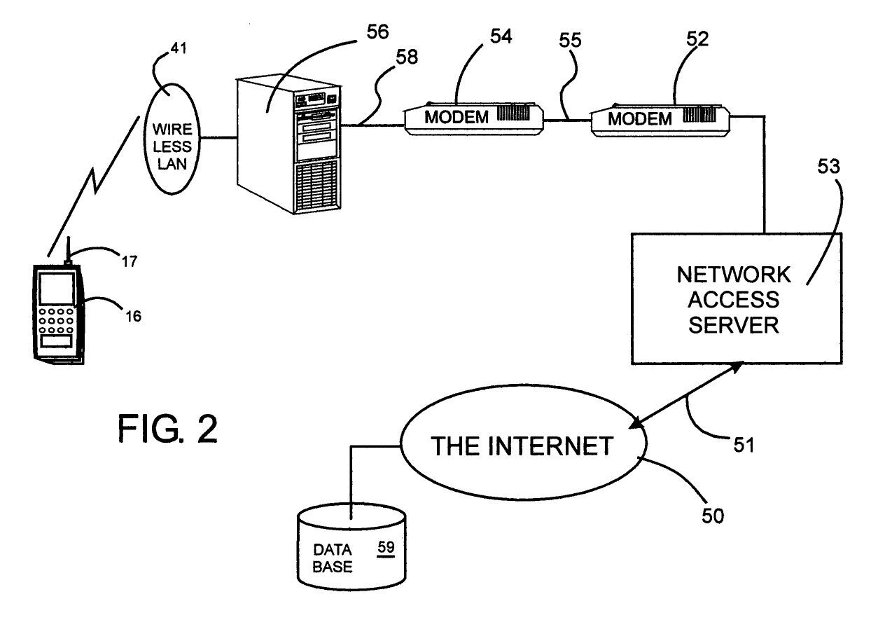

In this connection between the PDA 16 or other similar device having stored address information and the GPS, FIG. 2 provides a generalized system through which an individual mobile PDA may be connected to a database 59. Server 56, which functions like server 11 of the low power local wireless transmission system of FIG. 1, receives/transmits via LAN 41, FIG. 2, to/from wireless receiver terminal 17 of the PDA 16. Server 56 may function as a network server or be connected to a server which does. The server may access the Web or Internet via a host-dial connection through network access servers 53 which are linked 51 to the Internet 50. The host's server 53 is accessed by the server 56 through a normal dial-up telephone linkage 58 via modem 54, telephone line 55 and modem 52. The accessed outside database provides the user with requested information downloaded from the user's PDA 16 through controlling Internet server 53 via telephone line linkages from server 53 which may have accessed them from the Internet 50 via linkage 51. The connector that transfers the selected address information from the PDA 16 can be Bluetooth, infrared, cable, or some other connector. In addition to PDAs 16, a user could also transmit information from a cellular phone address book, laptop computer address book, or some other similar device that stores address information.

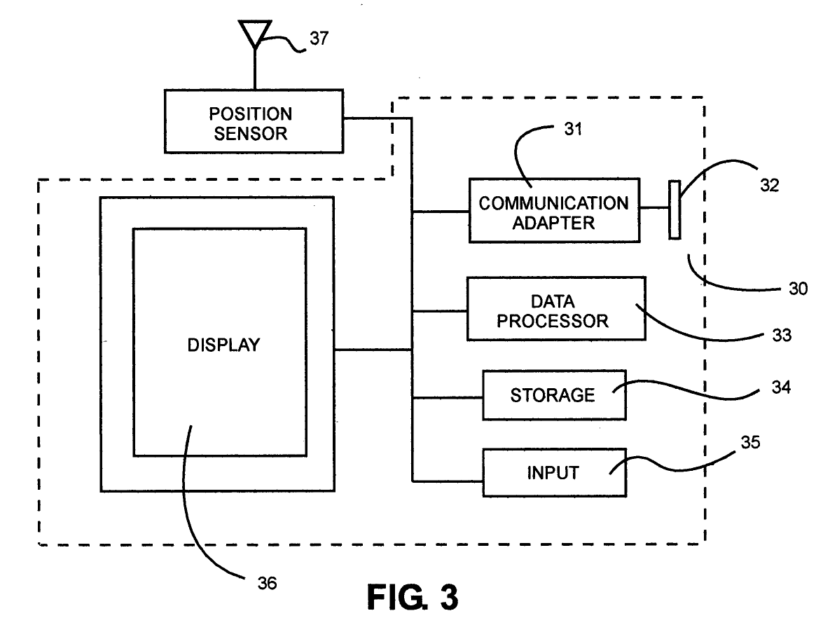

The PDA used may be any currently available model such as 3Com's PalmPilot™ series or IBM's WorkPad™. The basic elements of a PDA are shown in FIG. 3. The display 36 is supported by any standard data processing unit 33. There is storage 34 in the form of RAM. Personal user interactive input 35 is provided. As previously mentioned, low power wireless input/output is applied from the facility low power transmission terminal and received at antenna 32 of PDA 30 and then connected to the PDA via communication adapter 31. Positional data is sensed and if GPS is used, transmitted via antenna 37. Address information is also transmitted via antenna 37 from the PDA 30 to a GPS. Once the address information is transmitted into the GPS, the GPS address field is populated with the transmitted address information.

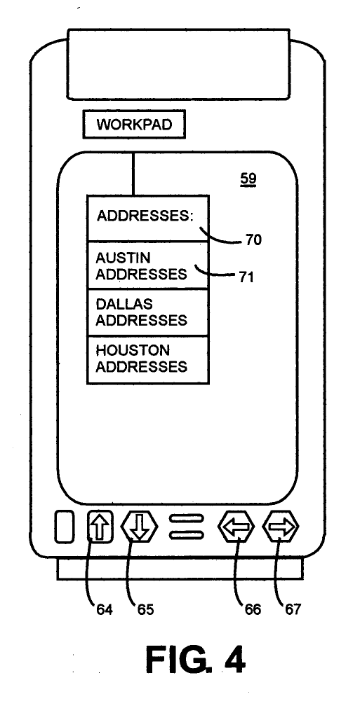

FIG. 4 shows an illustrative PDA 59 which shows the display 60 where address information can be seen when requested from the PDA 59. The PDA 59 is shown with conventional scrolling controls 64, 65, 66, and 67 for scrolling around the display and an interactive menu 70. Through this menu 70, the user may obtain access to address information 71 before transmitting the address information to a GPS. Once the address information is transmitted to a GPS, the GPS address fields are populated with the information.

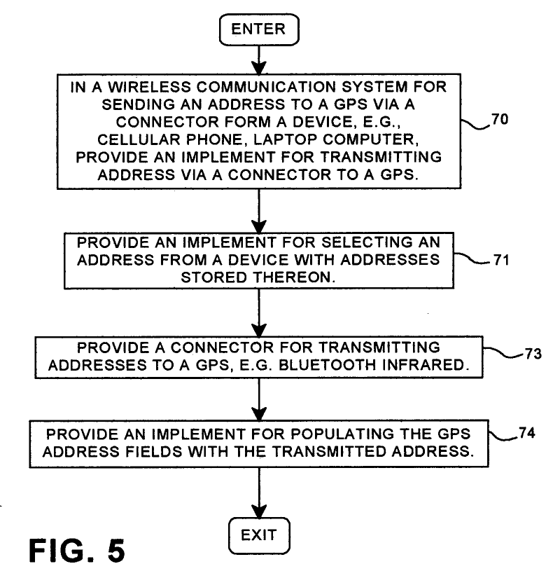

FIG. 5 is a flowchart showing the development of a process according to the present invention for enabling users of a global positioning system to transmit addresses stored on a different device, such as a cellular phone or laptop computer, to the global positioning system via a connector, such as Bluetooth, infrared, or cable, step 70. An implementation is provided for selecting an address from a device with addresses stored thereon that can be transmitted in this manner, step 71. A connector for transmitting addresses to the global positioning system is provided, such as Bluetooth, infrared, cable, or some other similar connector, step 72. An implementation for populating the address fields of the global positioning system with the transmitted addresses is provided, step 74.

A simplified run of the process set up in FIG. 5 and described in connection with FIGS. 1 through 4 will now be described. A user enters addresses into the user's global positioning system, step 80, by manually entering the addresses, step 81, transferring the addresses from a DVD, step 82, or by way of the present invention, which is to transmit addresses from a device that stores such addresses to the global positioning system via a connector, step 83. When transmitting the addresses to the global positioning system via a connector, the address information on a device that stores such address information is selected, step 84, and the addresses are transmitted to the global positioning system, step 85. Once the addresses have reached the global positioning system, the address field of the global positioning system is populated with the transmitted addresses, step 86.

Although certain preferred embodiments have been shown and described, it will be understood that many changes and modifications may be made therein without departing from the scope and intent of the appended claims.

1. A wireless communication system for sending one or more addresses to a global positioning system device via a connector from a device which stores addresses, comprising:
means for selecting one or more addresses from a device with addresses stored thereon;
means for transmitting via a connector one or more addresses to a global positioning system device; and
means for populating the address fields in the global positioning system device.

2. The wireless communication system of claim 1 wherein the device with addresses stored thereon is a personal digital assistant.

3. The wireless communication system of claim 1 wherein the device with addresses stored thereon is a cellular phone address book.

4. The wireless communication system of claim 1 wherein the device with addresses stored thereon is a laptop computer address book.

5. The wireless communication system of claim 1 wherein the connector for transmitting the addresses to a global positioning system device is Bluetooth.

6. The wireless communication system of claim 1 wherein the connector for transmitting the addresses to a global positioning system device is infrared.

7. A wireless communication method for sending one or more addresses to a global positioning system device via a connector from a device which stores addresses, comprising the steps of:
selecting one or more addresses from a device with addresses stored thereon;
transmitting via a connector one or more addresses to a global positioning system device; and
populating the address fields in the global positioning system device.

8. The wireless communication method of claim 7 wherein the device with addresses stored thereon is a personal digital assistant.

9. The wireless communication method of claim 7 wherein the device with addresses stored thereon is a cellular phone address book.

10. The wireless communication method of claim 7 wherein the device with addresses stored thereon is a laptop computer address book.

11. The wireless communication method of claim 7 wherein the connector for transmitting the addresses to a global positioning system device is Bluetooth.

12. The wireless communication method of claim 7 wherein the connector for transmitting the addresses to a global positioning system device is infrared.

13. In a wireless communication system, a computer program having code recorded on a computer readable medium for sending one or more addresses to a global positioning system device via a connector from a device which stores addresses, comprising:
means for selecting one or more addresses from a device with addresses stored thereon;
means for transmitting via a connector one or more addresses to a global positioning system device; and
means for populating the address fields in the global positioning system device.

14. The computer program of claim 13 wherein the device with addresses stored thereon is a personal digital assistant.

15. The computer program of claim 13 wherein the device with addresses stored thereon is a cellular phone address book.

16. The computer program of claim 13 wherein the device with addresses stored thereon is a laptop computer address book.

17. The computer program of claim 13 wherein the connector for transmitting the addresses to a global positioning system device is Bluetooth.

18. The computer program claim 13 wherein the connector for transmitting the addresses to a global positioning system device is infrared.
